(19) United States
(12) Patent Application Publication
(10) Pub. No.: US 2001/0032928 A1
(43) Pub. Date: Oct. 25, 2001

(54) Method and apparatus for surveying hydrocarbon reserves

(76) Inventor: Daniel E. Boone, Houston, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 09/776,330

(22) Filed: Feb. 2, 2001

Related U.S. Application Data
(60) Provisional application No. 60/180,033, filed on Feb. 3, 2000.

(51) Int. Cl. G01V 5/00

(52) U.S. Cl. 250/253

(57) ABSTRACT

A system and method for performing a radiological survey to identify subterranean hydrocarbon reserves. In one embodiment, the system includes a vehicle which serves as a platform for a radiation detector and a position sensing system. The radiation detector takes continuous measurements of surface radiation as the vehicle traverses the survey area, thereby measuring an average of the radiation over a portion of the vehicle's path. As each radiation measurement is taken, corresponding position information is generated by the position sensing system and recorded. In one embodiment, the position sensing system comprises a global positioning system which produces coordinates corresponding to the radiation measurements. The data generated by the system can be used to produce radiological maps of the survey area. The data can also be used to calculate the volume of hydrocarbon reserves underlying the survey area. Generally speaking, low radiation levels indicate the presence of hydrocarbon reserves.

### RELATED APPLICATIONS

This application claims priority from the U.S. provisional patent application entitled “Method and Apparatus for Surveying Hydrocarbon Reserves”, by Daniel E. Boone, Ser. No. 60/180,033 filed Feb. 3, 2000.

### FIELD OF THE INVENTION

The present invention relates generally to oilfield surveying and more specifically to a method and apparatus for making near-surface radiological measurements of a survey area to determine the presence and amount of hydrocarbon reserves at depth.

### DESCRIPTION OF RELATED ART

Various types of radiation measurements have been used for many years in the oil industry to determine lithology, sand-shale boundaries and clay content in sands. Tools and processes have been developed to estimate porosity, gas saturation in open hole logs and hydrocarbon saturation behind casings.

For example, radiation measurements are used to determine pore saturation around selected areas in a well bore. In conventional neutron testing, a downhole tool which is designed to emit a burst of neutrons is lowered into a well bore. The tool is positioned in a zone of interest in the well bore. After a burst of neutrons is released, the radiation is measured by the tool in 200 microsecond increments. The time which it takes for the radiation to leave the well bore is dependent upon the transmissivity of the formation in the zone of interest, which is in turn dependent upon pore saturations. Since the transmissivity of various pore saturations is known, the well bore saturation can be determined from the measurements of the neutron radiation. It would be desirable, however, to be able to measure pore saturation in an entire field rather than only around a well bore, and consequently to be able to determine related information such as the volume of reserves in the field. It would also be desirable to obtain this information without having to incur the cost of drilling a well bore.

In another example, radiation measurements are used to perform hydrocarbon prospecting surveys. In one survey process, the area to be surveyed is mapped out and specific points are selected for making radiation measurements. At each of the selected points, background radiation is measured above the ground. This measurement is made with a geiger counter having its receiving window closed. The geiger counter is then placed on the ground with its receiving tube open to measure surface radiation. The difference between these measurements is then plotted to generate a contour georadiograph map of the surveyed area. Reduced levels of radiation correspond to absorption of the radiation by hydrocarbon deposits. While this process can be performed without having to drill one or more well bores, it may be tedious and time-consuming because the specific locations at which radiation measurements which are to be taken must be mapped out and the corresponding physical location determined. Then, the measurement apparatus must be set up at each of these locations, the measurements must be taken, and the apparatus must be moved to the next location. Further, the actual radiation measurements may include error introduced by random radioactive rock having higher-than-average levels of radiation.

### SUMMARY OF THE INVENTION

One or more of the problems outlined above may be solved by the various embodiments of the present invention. Broadly speaking, the invention comprises a system and method for surveying the radiation levels of a geographic location to identify subterranean hydrocarbon reserves. In one embodiment, the invention comprises an improved system for collecting radiation measurements over the survey area. The system includes a vehicle which serves as a platform for a radiation detector and a position sensing system. As the vehicle traverses the survey area, the radiation detector takes continuous measurements of the radiation emanating from the ground. In one embodiment, the radiation level and position are recorded at three second averaged increments. The movement of the vehicle causes the radiation detector to take a measurement which covers a portion of the vehicle's path rather than a single point on the ground, thereby resulting in an average reading over a segment (typically five to twenty feet) of the vehicle's path. As each radiation measurement is taken, corresponding position information is generated by the position sensing system. In one embodiment, the position sensing system comprises a magnetic sensor coupled to the driveshaft of the vehicle. As the vehicle moves, the rotation of the driveshaft is detected and a corresponding output signal is generated. This signal is used to advance a chart recorder on which the detected radiation levels are plotted. The resulting graph can then be analyzed manually, or selected portions of the graph can be entered into a computer for automated analysis. In another embodiment, the position sensing system comprises a global positioning system. The coordinates provided by the global positioning system are automatically entered into a computer with the corresponding radiation measurements. This information is stored in a data file for later analysis, although it may be interpreted as it is produced. The computer may employ existing software applications to generate three-dimensional maps (radiation level being the Z coordinate), or to provide other analysis of the data.

Another embodiment comprises a method for surveying a geographic location to determine the radiation levels of the area and to thereby identify hydrocarbon reserves. The method comprises collecting radiation data and corresponding location data from which a radiation profile of the area can be constructed. Radiation data is collected by using a moving radiation detector to measure an average level of radiation over a certain path within the survey area. In this embodiment, the radiation detector is mounted to a vehicle which is moving along a path within the survey area. During the time interval in which a radiation measurement is taken, an indication of a position corresponding to the radiation measurement is also recorded. In one embodiment, the position is determined by using a magnetic sensor on the driveshaft of the vehicle to measure the travel of the vehicle along a predetermined path. In another embodiment, the position is determined by using a global positioning system to provide the coordinates of the vehicle. In this embodiment, the position and radiation data is preferably stored in a computer as it is obtained. In one embodiment, approximately 640 data points are obtained per acre of the survey area (approximately 200,000 points for a 300-acre area). A software application is then used to interpolate the data to obtain points on a regular grid. The radiation levels can then be mapped over the survey area in various ways (e.g., colored contour images may be generated.) The data can also be used to calculate the volume of hydrocarbon reserves underlying the survey area.

### BRIEF DESCRIPTION OF THE DRAWINGS

Other objects and advantages of the invention will become apparent upon reading the following detailed description and upon reference to the accompanying drawings in which:

FIG. 1 is a graph of radiation levels along the path in a survey area as generated by one embodiment of the present system;

FIG. 2 is a two-dimensional contour image of a survey area showing the level of radiation as a function of location;

FIG. 3 is a three-dimensional contour image of the survey area of FIG. 2 showing the level of radiation as a function of location.

While the invention is susceptible of various modifications and alternative forms, specific embodiments thereof are shown by way of example and will herein be described in detail. It should be understood, however, that the drawings and detailed description thereof are not intended to limit the invention to the particular form disclosed, but, on the contrary, the intention is to cover all modifications, equivalents and alternatives falling within the scope of the present invention as defined by the appended claims.

### DETAILED DESCRIPTION OF A PREFERRED EMBODIMENT

A preferred embodiment of the invention is described below. It should be noted that this and any other embodiments described below are exemplary and are intended to be illustrative of the invention rather than limiting.

Broadly speaking, this disclosure is directed to an improved system and method for recording radiation levels over a survey area to identify subterranean hydrocarbon reserves. The molten core of the earth produces radiation which is transmitted through the earth's crust to its surface. The amount of radiation which is transmitted to the surface is dependent in part upon whether the radiation is transmitted through hydrocarbons and, if so, the type and amount of the hydrocarbons. Further, the inherent radioactivity of rock formations is at least in part dependent upon the presence of hydrocarbons in the formations. Shales that overlie hydrocarbons have lower radioactivity than the same shale beyond the reservoir boundaries. The resulting radiation pattern can be observed through all of the overlying sediments to the surface.

Radioactivity from the earth's core migrates through the earth's crust in a random process of bombardment and decay which is well-known in the field of nuclear physics. Through this process, radiation generated at the earth's core moves generally radially through radioactive rocks, minerals and water. For example, the radiation may pass through sedimentary basins where saltwater, oil or gas may be stored in the pores of porous rocks. The ease with which radiation passes through these porous formations depends at least in part upon the presence of saltwater, oil or gas in these pores.

To more clearly define the decrease in radiation passing through hydrocarbon reservoirs, consider the definitions from the WordPerfect reference manual, version 5.1 (1989) and The Health Physics Handbook:

Absorption: “the process by which radiation imparts some or all of its energy to any material through which it passes.” Attenuation factor: “a measure of the opacity of a layer of material for radiation traversing it; the ratio of the incident intensity to the transmitted intensity. It is equal to Io/I, where Io and I are the intensities of incident and emergent radiation, respectively. In the usual sense of exponential absorption (I=Iₒe^{-mx}) the attenuation factor is e^{-mx}, where x is the thickness of the material and m is the absorption coefficient.”

The significant difference between the absorption coefficients of salt water and hydrocarbons (oil or gas,) present in a porous reservoir of common thickness, precisely explains the reduction in radiation intensity over hydrocarbon reservoirs.

If a two inch diameter scintillation crystal is used to measure the amount of surface radiation (i.e., the gross gamma ray spectrum in one embodiment,) approximately 80-90 counts per second will be measured when the pore spaces of the subsurface formation are filled with salt water (this baseline level of radiation may vary somewhat, depending primarily upon the diameter of the radiation detector.) If the pore spaces are filled with hydrocarbons, as in a productive oil or gas reservoir, the radioactivity measured at the surface decreases significantly. While the radiation passes through the rock and interstitial water with little attenuation, many of the radioactive particles which encounter the hydrocarbons are impeded in the vertical path and migrate to the reservoir boundaries. This results in reduced levels of radiation over and oil or gas deposit, with a radiation halo around the boundaries of the deposit. The variations in the levels of radiation are quantitatively related to the underlying hydrocarbon reserves. The variations are also qualitatively related to the underlying reserves, as natural gas absorbs approximately twice as much radiation as oil.

In one embodiment, the invention comprises a system for measuring the level of surface radiation at thousands of points across a particular area being surveyed, then building a radiation contour map of the survey area which indicates the volume of hydrocarbon reserves beneath the surface. The level of radiation is measured by an ordinary radiation detector which is carried on a mobile platform such as a four-wheel-drive vehicle. (“Platform” is used here simply to refer to the means for carrying the survey equipment, and in other embodiments may comprise any means for transporting the equipment, including all-terrain vehicles, remotely controlled vehicles, boats, or even packages that are transportable by pack animals or humans.) As the vehicle crosses the survey area (preferably in a grid or similar pattern and at a relatively constant rate of speed,) radiation measurements are continuously obtained. That is, the amount of radiation which is detected during a series of consecutive three-second time periods is obtained. The movement of the vehicle causes the radiation detector to measure what is effectively an average value for the five to twenty foot distance covered by the vehicle during the corresponding time period (assuming a speed of 1-5 miles per hour.) It should be noted that, in different embodiments, different intervals for the measurements can be used, and different distances may be covered in the corresponding intervals. Also, it is not necessary that the measurements be taken continuously—the measurement intervals may be separated by periods during which no radiation counts are accumulated.

As the radiation measurements are being obtained, position information is also being obtained. Each radiation measurement can therefore be associated with a particular position. For the purposes of constructing a three-dimensional radiological map of the surveyed area, the position information provides the X and Y coordinates for each point, while the radiation information provides the corresponding Z coordinates. Although the embodiments described herein incorporate position sensors which are positioned at or near the radiation detector, it should be noted that the position sensing system may be remotely located in other embodiments.

In one embodiment, the radiation detector comprises a scintillation crystal of the type customarily used to make radiation measurements in oilfield surveys. The crystal may, for example, utilize a sodium iodide crystal to which a potential of approximately 800 volts is applied. When a radioactive particle passes through the crystal, it leaves a visible light trace. A photomultiplier tube is located above the crystal to detect the presence of these traces and to produce a signal indicative of the traces. These signals (which correspond to light bursts) are then counted to determine the level of radiation in counts per second. It should be noted that the radiation detectors of this and other types are well-known in the art and that many different detectors may be suitable for this application.

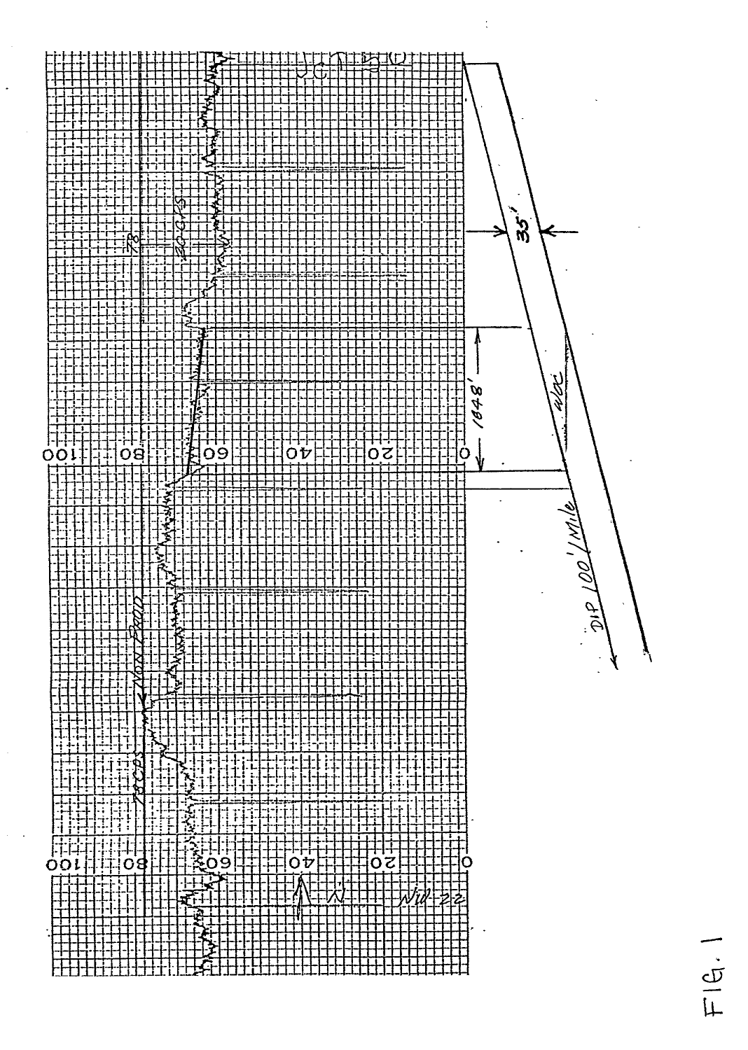

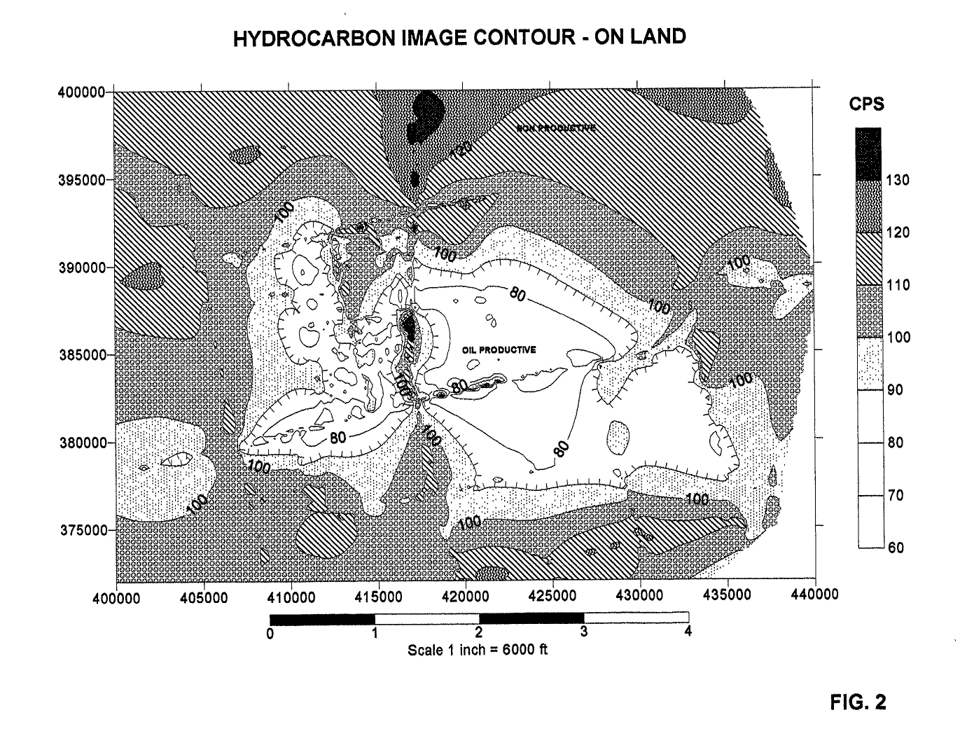

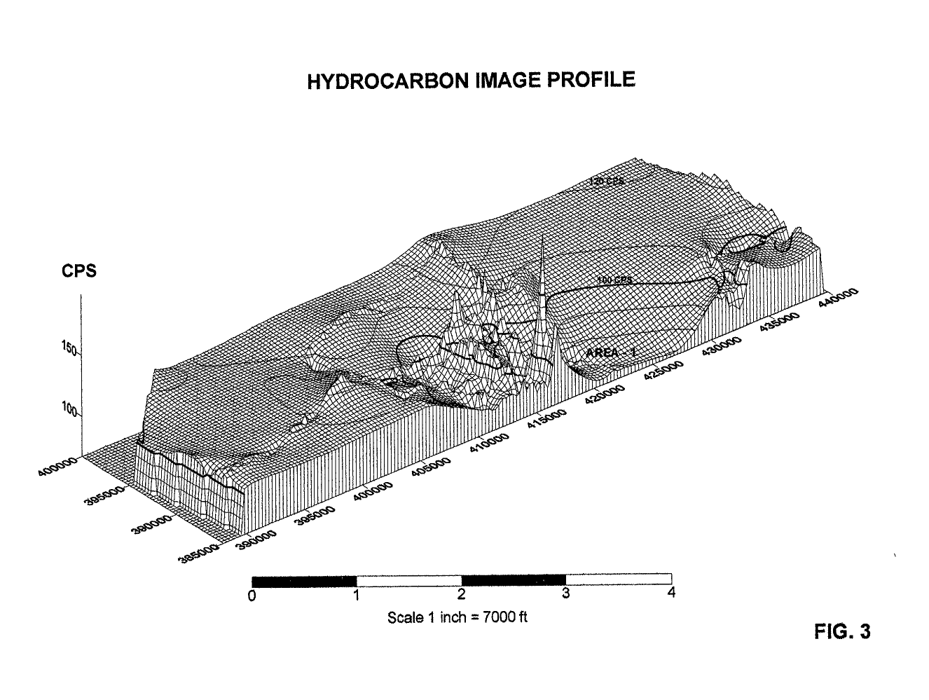

In one embodiment where the survey area is onshore, the radiation detector is mounted approximately 16-18 inches above the ground. (It has been observed that the amount of radiation detected does not vary substantially as a function of the height of the detector between ground level and 18 inches, but the signal decreases significantly at more than approximately four feet above the ground.) The output of the radiation detector is connected to a chart recorder in the vehicle. The signals produced by the detector are plotted on a continuous graph produced by the recorder. In this embodiment, the recorder is also connected to a sensor which is coupled to the driveshaft of the vehicle in which the system is installed. As the driveshaft turns, the sensor generates a signal corresponding to the distance over which the vehicle has traveled. This signal is used to advance the chart in the recorder. The system therefore produces a graph of the radiation levels along the path of the vehicle. (See FIG. 1.) The sensor can be calibrated to advance the chart at a predetermined rate, thereby setting the horizontal scale of the chart (e.g., N inches per 1000 feet.) Although the resulting graph is only two-dimensional (radiation level versus path length,) the vehicle can make multiple passes across the field being surveyed, and the two-dimensional graph can be reinterpreted as a two-dimensional map (e.g., a contoured X-Y map as shown in FIG. 2) or as a three-dimensional map (e.g., a contoured X-Y-Z map as shown in FIG. 3,) although it is more difficult in this embodiment than in embodiments using computerized data collection and interpretation. In this embodiment, the path of the vehicle should follow a regular grid as closely as possible in order to simplify the analysis of the resulting data as a function of position.

In another embodiment, the vehicle is equipped with a radiation detector generally as described above, but the output of the detector is converted to a digital format suitable for input to a computer system. The computer system may be a general-purpose personal computer or a special-purpose computer which is configured specifically to accept the radiation measurement data. The computer is also connected to a global positioning system. Such systems are widely available and can provide accurate information as to the position of the vehicle and the radiation detector. As each radiation measurement is taken, the global positioning system provides a location corresponding to the radiation measurement. In this embodiment, the radiation measurement is paired with a position measurement which is midway along the path over which the radiation counts were accumulated in order to avoid shifting the measurements in the direction of travel of the radiation detector. While the global positioning system will typically be able to provide three-dimensional position information, normally only the X and Y coordinates will be used (the Z coordinates, or surface elevation, is simply not recorded.) In other embodiments which employ more sophisticated modeling software, however, it may be useful to utilize all three coordinates from the GPS.

Since the computer automatically receives the radiation and position measurements directly from the corresponding sensors, the system can potentially take more data points in less time than the system in which the information is graphed and must be interpreted by hand. Preferably, the computer is configured with software which stores the data points (in a data file at five-minute intervals during the survey) and produce two- or a three-dimensional maps of the radiation levels over the surveyed area (see FIGS. 2 and 3.)

After the position and radiation data are obtained, they can be interpreted using existing software applications. For example, applications can plot the data as a three-dimensional map (with the position data providing the X and Y coordinates and the radiation data providing the Z coordinate.) The resulting maps can be color contoured or otherwise manipulated to facilitate their interpretation. The survey data can be examined to determine areas which are outside the boundaries of the hydrocarbon reserves. Non-productive areas have a consistent high level of radiation, indicating that there are no reserves under those particular locations. Productive areas have lower radiation levels. These software applications can also be useful in calculating the volume of hydrocarbon reserves underlying the survey area.

Oil and gas reserves in the productive areas are volumetrically proportional to the decrease in radiation levels from the non-productive areas (e.g., as measured in counts per second). Multiplying the counts per second decrease at a location times a proportionality constant provides the reserves (in barrels per acre) underlying that location. Using the two-inch scintillation crystal described above, the radiation level of non-productive areas was found to be approximately 105 counts per second, and the proportionality constant was found to be approximately 1000 barrels per acre per count. These values may vary, depending upon the detector used, and the survey conditions. For example, a larger diameter crystal will measure a higher number of counts per second than the two-inch crystal. A survey of an offshore area will typically measure lower radiation levels than a similar area onshore. In either of these cases, if the measured radiation levels for non-productive areas are normalized to about 105 counts per second, the 1000 barrels per acre per count proportionality constant can be used to determine the volume of the reserves.

In another example, a slightly larger diameter crystal was used. The level of radiation corresponding to non-productive portions of the survey area was found to be approximately 185 counts per second. After measurements were taken at a number of points across the survey area, the data was interpolated at points on a regular grid to facilitate the generation of images based on the data as well as the analysis of the data. FIG. 2 is a two-dimensional contour map of the survey area. The various radiation levels throughout the survey area are indicated by the different fill patterns. It can be seen from this figure that low radiation defines the most productive portion of the survey area which is generally in the center of the mapped area and corresponds to radiation levels of 80 counts per second or less. FIG. 3 is a three-dimensional map of the same data, where the Z-axis is the radiation level. This figure actually represents the upper portion of the survey area (385000<Y<400000). The figure was sectioned at Y=385000 in order to better illustrate the lower radiation levels in the productive area (centered at approximately X=425000.)

Based upon the information represented by FIGS. 2 and 3, the volume of oil underlying a productive portion of the survey area can be calculated. In this example, the productive portion of the survey area is defined by the ranges

416000<X<437000

375000<Y<393000

These ranges represent a grid size of 162 columns by 139 rows. Each square of the grid is approximately 130 [feet] by 130 [feet]. For each point within the defined ranges, the difference between the corresponding radiation level and the non-productive level (185 counts per second) is multiplied by the area associated with that grid point (130 [feet] times 130 [feet].) These products are then summed over the defined ranges. The total is then multiplied by a proportionality constant which has been empirically determined to be approximately 0.01377 [units]. Thus, over the 8677 acres covered by the defined ranges within the survey area, the average reserves are 55,434 barrels per acre, and the total reserves underlying these ranges are 481 million barrels.

It should be noted that the proportionality constant is dependent in part upon the detector and in part upon the type of hydrocarbons which are stored in the reserves underlying the survey area. For instance, if the detector measurers a nonproductive level of radiation which is twice that of the detector above (185 counts per second,) the proportionality constant will be halved. The dependence of the proportionality constant upon the type of hydrocarbon can also be empirically determined. For instance, oil absorbs less radiation then natural gas, so the proportionality constant corresponding to oil will be less than the proportionality constant corresponding to natural gas. There are also various grades of oil which exhibit varying degrees of radiation absorption. Thus, the degree of absorption and the corresponding proportion of the constant can be empirically determined for each of these grades. Then, based upon actual production or some type of traditional analysis, the grade of oil expected to be found in a survey area can be determined and a corresponding proportionality constant can be selected.

The present systems and methods are not limited to use in onshore survey areas. They can also be used in various offshore environments. For example, one embodiment of the present method is designed for shallow-water offshore survey areas. In this type of environment, (e.g., 30-40 feet deep,) a radiation detector similar to the one used in onshore surveys can simply be installed on a boat or other vessel, and radiation measurements can be taken with the crystal placed inside the boat below the water line. In one such survey, the level of radiation over nonproductive portions of the survey area was found to be 35 counts per second. In order to calculate the underlying hydrocarbon reserves, the measured radiation levels were simply normalized to the level of non-productive radiation identified above, and the calculation was performed using the same proportionality constant. Alternatively, the actual measured levels of radiation could be used, and the proportionality constant adjusted based upon the different level of non-productive radiation.

In offshore environments in which the depth of the water is substantially greater than that described above, an alternative embodiment of the present method may be used. In this embodiment, the radiation detector is towed along the seafloor, rather than being mounted on a boat. While the radiation detector will need to be configured for use underwater in this embodiment (and the position sensing system as well,) the method itself is much the same as the embodiment described above for onshore environments. It is expected that the levels of radiation measured in this embodiment will be similar to those measured onshore using a comparable radiation detector.

While the present invention has been described with reference to particular embodiments, it will be understood that the embodiments are illustrative and that the invention scope is not limited to these embodiments. Many variations, modifications, additions and improvements to the embodiments described are possible. These variations, modifications, additions and improvements are contemplated to fall within the scope of the invention as detailed herein.

What is claimed is:

1. A method comprising:
measuring radiation levels at a plurality of points in a survey area;
determining locations of the plurality of points at which the radiation levels are measured;
recording the radiation levels and corresponding locations of the plurality of points; and
calculating a volume of hydrocarbon reserves underlying the survey area based upon the radiation levels and corresponding locations of the plurality of points.

2. The method of claim 1 wherein the plurality of points in the survey area are irregularly spaced, wherein the method further comprises interpolating radiation levels at a plurality of points on a regular grid over the survey area; for each point on the regular grid, calculating a product of an incremental area between points on the regular grid times an amount by which the radiation level corresponding to that point falls below the level of radiation corresponding to non-productive portions of the survey area and times a proportionality constant; and summing the products of the points on the regular grid to obtain a volume of hydrocarbons underlying the survey area.

3. The method of claim 1 wherein calculating the volume of hydrocarbon reserves comprises identifying a level of radiation corresponding to non-productive portions of the survey area, determining amounts by which the radiation levels in the survey area fall below the level of radiation corresponding to non-productive portions of the survey area, and summing over at least a portion of the survey area the products of the incremental area times the amounts by which the radiation levels in the survey area fall below the level of radiation corresponding to non-productive portions of the survey area times a proportionality constant.

4. A method comprising:
measuring radiation levels at a plurality of points in a survey area;
determining locations of the plurality of points at which the radiation levels are measured;
recording the radiation levels and corresponding locations of the plurality of points;
identifying a level of radiation corresponding to non-productive portions of the survey area; and
identifying productive portions of the survey area which have corresponding radiation levels that are less than the level of radiation corresponding to non-productive portions of the survey area.

5. The method of claim 4 wherein the plurality of points in the survey area are irregularly spaced, wherein the method further comprises interpolating radiation levels at a plurality of regular grid points over the survey area.

6. The method of claim 4 further comprising plotting the radiation levels corresponding to the regular grid points over the survey area.

7. The method of claim 4 wherein measuring radiation levels at the plurality of points in the survey area comprises measuring average radiation levels over a path across the survey area.

8. The method of claim 7 wherein measuring average radiation levels over a path across the survey area comprises measuring radiation levels using a radiation detector which is moved along the path across the survey area, wherein the radiation detector is configured to accumulate radiation counts, and wherein the radiation counts over a path segment are averaged and assigned to a point midway along the path segment.

9. The method of claim 4 wherein the survey area is offshore and wherein radiation levels are measured using a radiation detector which is configured to be pulled across the sea floor.

10. A system comprising:
a radiation detector configured to measure levels of radiation emitted from the earth at a plurality of points in a survey area;
a platform configured to transport the radiation detector over the survey area;
a position sensor configured to determine position data for the radiation detector at the plurality of points in the survey area; and
a data recorder configured to receive the radiation data from the radiation detector and the position data from the position sensor corresponding to each of the plurality of points in the survey area.

11. The system of claim 10 wherein the platform comprises a vehicle.

12. The system of claim 11 wherein the vehicle comprises an automobile.

13. The system of claim 11 wherein the vehicle comprises a boat.

14. The system of claim 11 wherein the position sensor comprises a magnetic sensor coupled to a driveshaft of the vehicle; wherein the data recorder comprises a chart recorder which is configured to plot a measured level of radiation on a strip chart; and wherein the chart recorder is coupled to the magnetic sensor and is configured to advance the strip chart in response to signals from the magnetic sensor.

15. The system of claim 10 wherein the platform is configured to support the radiation detector at a height of approximately 18 inches above the surface of the survey area.

16. The system of claim 10 wherein the position sensor comprises a global positioning system (GPS) sensor.

17. The system of claim 10 wherein the data recorder comprises a computer and wherein the computer is configured to store a radiation level measurement and a position corresponding to each of the points in the survey area.

18. The system of claim 17 wherein the computer is further configured to generate a visual display of the level of radiation over the survey area as a function of position.

19. The system of claim 17 wherein the computer is further configured to calculate a volume of hydrocarbon reserves in the survey area based upon the radiation level measurements and corresponding positions.

20. The system of claim 10 wherein the radiation detector is configured to measure the level of radiation at each of the plurality of points in the survey area by accumulating radiation counts as the radiation detector is moved from a previous point in the survey area to a current point in the survey area.

21. The system of claim 10 wherein the data recorder is remotely located from the radiation detector.

22. The system of claim 10 wherein the system is configured to accumulate radiation counts over a path segment and to associate an average radiation level over the path segment to a point midway along the path segment.
